(19) United States
(12) Patent Application Publication
(10) Pub. No.: US 2018/0185988 A1
(43) Pub. Date: Jul. 5, 2018

(54) Worktable Clamp Structure

(71) Applicants: Shun Sheng Lin, Taichung City (TW); Cheng Kuo Lee, Taichung City (TW); TAI FONG PNEUMATIC TOOLS CO., LTD., Taichung City (TW)

(72) Inventor: Shun Sheng Lin, Taichung City (TW)

(73) Assignees: Shun Sheng Lin; Cheng Kuo Lee; TAI FONG PNEUMATIC TOOLS CO., LTD.

(21) Appl. No.: 15/416,741

(22) Filed: Jan. 26, 2017

(30) Foreign Application Priority Data
Jan. 5, 2017 (TW) 106200168

(51) Int. Cl. B25B 5/02; B25B 5/10; B25B 5/16

(52) U.S. Cl. CPC B25B 5/02; B25B 5/16; B25B 5/10

(57) ABSTRACT

A worktable clamp structure includes a clamp unit, a bushing unit, and a worktable. The worktable includes a tabletop and a frame. Each side edge of the frame has a plurality of pairs of side perforations, and a central perforation is provided between each pair of the side perforations. The bushing unit is inserted and fixed to and the side perforations and the central perforation of the frame of the worktable. The clamp unit is movably mounted to the bushing unit. The clamp unit and the bushing unit can be mounted to the side perforations and the central perforation at either side edge of the frame of the worktable according to the demand, without the need to fix the clamp unit to the tabletop of the worktable in a destructive manner. This can prevent deformation of a clamping seat due to the force applied thereto to achieve structural stability and ease of use.

### FIELD OF THE INVENTION

The present invention relates to a clamp structure, and more particularly to a clamp structure applied to a worktable.

### BACKGROUND OF THE INVENTION

As shown in FIG. 6, a conventional woodworking clamp device comprises a worktable 30 and at least one clamp unit 40. The worktable 30 includes a tabletop 31. The tabletop 31 is formed with a plurality of engaging holes 310 close to an edge thereof. The clamp unit 40 includes a locking seat 41 and a clamping seat 42. The locking seat 41 has two through holes 410 extending from front to back and a screw hole 411 disposed between the two through holes 410. The top of the locking seat 41 is provided with a number of locking members 412. The clamping seat 42 is provided with two support rods 420 at two sides thereof and a movable screw rod 421 between the two support rods 420. The two support rods 420 of the clamping seat 42 are rotatably inserted through the two through holes 410 of the locking seat 41. The screw rod 421 of the clamping seat 42 is screwed to the screw hole 411 of the locking seat 41. The locking members 412 provided on the top of the locking seat 41 are engaged with the engaging holes 310 provided at the edge of the tabletop 31 of the worktable 30. By rotating the screw rod 421 of the clamping seat 42, the clamping seat 42 is displaced to approach the locking seat 41 so as to clamp and process the workpiece. A downward force is applied to the workpiece during the process, so the locking seat 41 and the clamping seat 42 are subjected to the downward applied force. The applied force may damage the locking seat 41 or the edge of the tabletop 31 of the workable 30. The locking members 412 of the locking seats 41 are locked to the bottom of the edge of the tabletop 31 of the worktable 30 in a destructive manner. If the user wants to move the clamp unit 40 to another position of the tabletop 31 of the worktable 30, the tabletop 31 is again subjected to the destructive locking. As a result, the tabletop 31 of the worktable 30 is poor in integrity. There is a problem that it is poor in structural stability and in convenience of use. Accordingly, the inventor of the present invention has devoted himself based on his many years of practical experiences to solve these problems.

### SUMMARY OF THE INVENTION

In view of the known problem of the structural stability and usability of the conventional woodworking clamp device, a worktable clamp structure of the present invention is completed accordingly.

The primary object of the present invention is to provide a worktable clamp structure. The worktable clamp structure comprises a clamp unit, a bushing unit, and a worktable. The clamp unit includes a clamping seat. The clamping seat is provided with two support rods at two sides thereof and a rotatable screw rod between the two support rods. The two support rods and the screw rod of the clamping seat are arranged in a non-relativistic horizontal state. The bushing unit includes at least two insertion bushings and at least one screw bushing. A front end of each insertion bushing is provided with a first front stopper. A rear end of each insertion bushing has a first rear screw portion. The first rear screw portion is provided with a first fastening member. Each insertion bushing has a through hole extending from front to back. A front end of the screw bushing is provided with a second front stopper. A rear end of the screw bushing has a second rear screw portion. The second rear screw portion is provided with a second fastening member. The screw bushing has an inner screw hole extending from front to back. The worktable includes a tabletop and a frame fixedly connected to the tabletop. Each of side edges of the frame is provided with a plurality of pairs of side perforations. A central perforation is provided between each pair of the side perforations. Each pair of the side perforations and the central perforation are arranged in a non-relativistic horizontal state. The two insertion bushings of the bushing unit are inserted through a corresponding pair of the side perforations of the frame, and the first screw portions at the rear ends of the two insertion bushings extend out of the pair of the side perforations and are locked with the first fastening member. The screw bushing is inserted through the central perforation of the frame, and the second rear screw portion at the rear end of the screw bushing extends out of the central perforation and is locked with the second fastening member. The two support rods of the clamp unit are slidably inserted through the two insertion bushings of the bushing unit. The screw rod of the clamp unit is movably threadedly connected to the screw bushing of the bushing unit. The clamp unit and the bushing unit can be mounted to the side perforations and the central perforation at either side edge of the frame of the worktable according to the demand, without the need to fix the clamp unit to the tabletop of the worktable in a destructive manner. This can prevent deformation of the clamping seat due to the force applied thereto to achieve structural stability and ease of use.

### BRIEF DESCRIPTION OF THE DRAWINGS

FIG. 1 is a perspective view of a worktable clamp structure according to an embodiment the present invention;

FIG. 2 is a partial exploded view of the worktable clamp structure according to the embodiment the present invention;

FIG. 3 is a schematic and partial enlarged view showing the operation of the worktable clamp structure according to the embodiment the present invention;

FIG. 4 is a schematic view showing the clamp unit and the bushing unit mounted the side edge of the worktable of the worktable clamp structure according to the embodiment the present invention;

FIG. 5 is a schematic view showing the stop boards provided at the side edges of the workatable according to another embodiment of the present invention; and

FIG. 6 is a perspective and partial exploded view of a conventional woodworking clamp device.

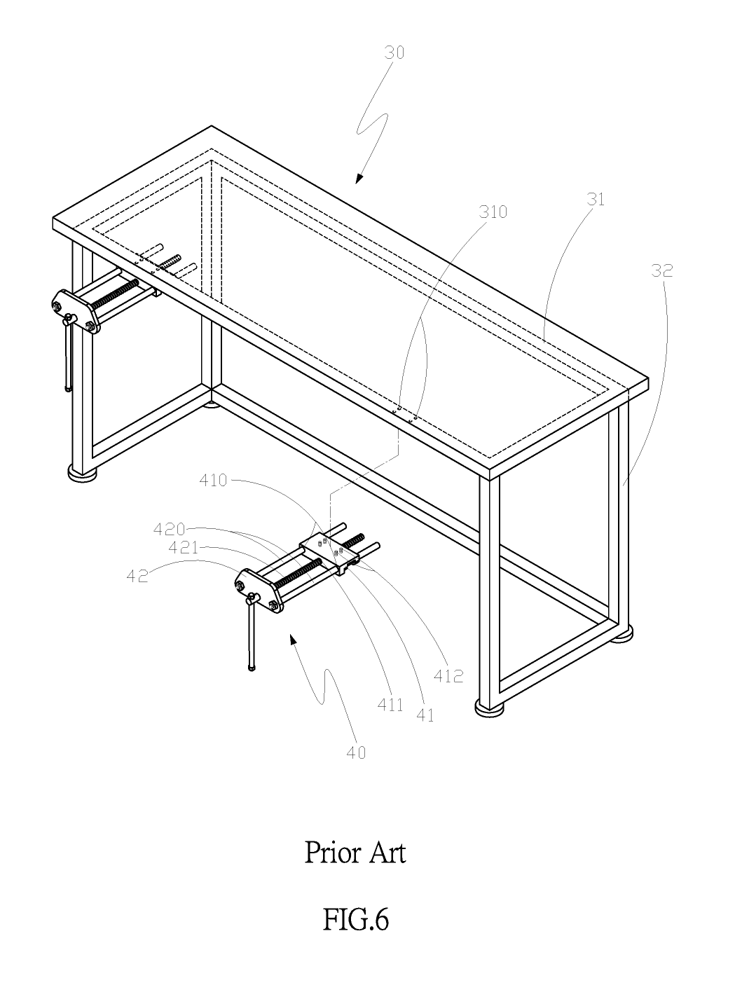

### DETAILED DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

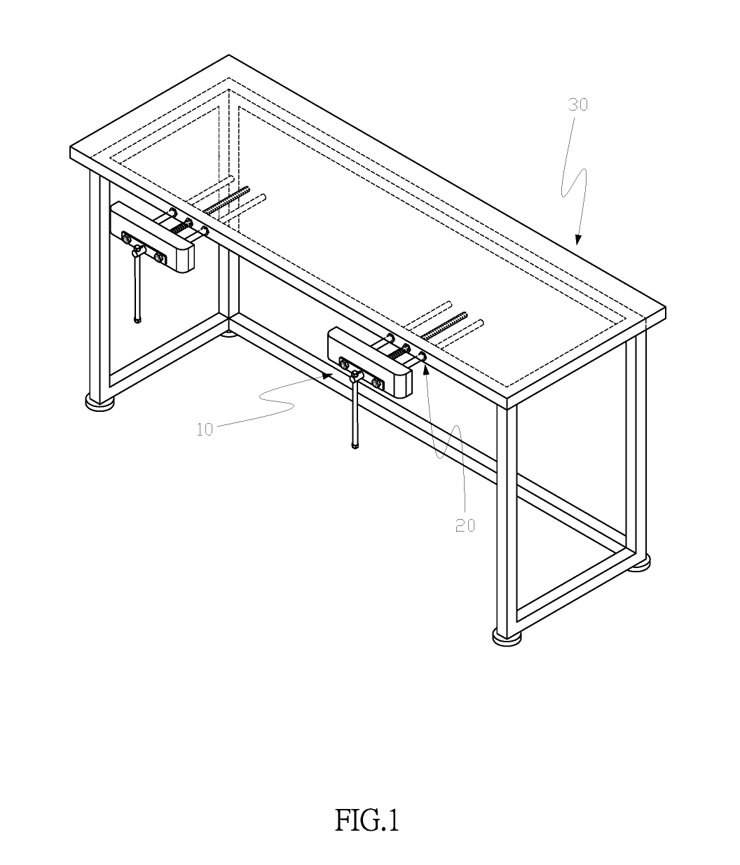

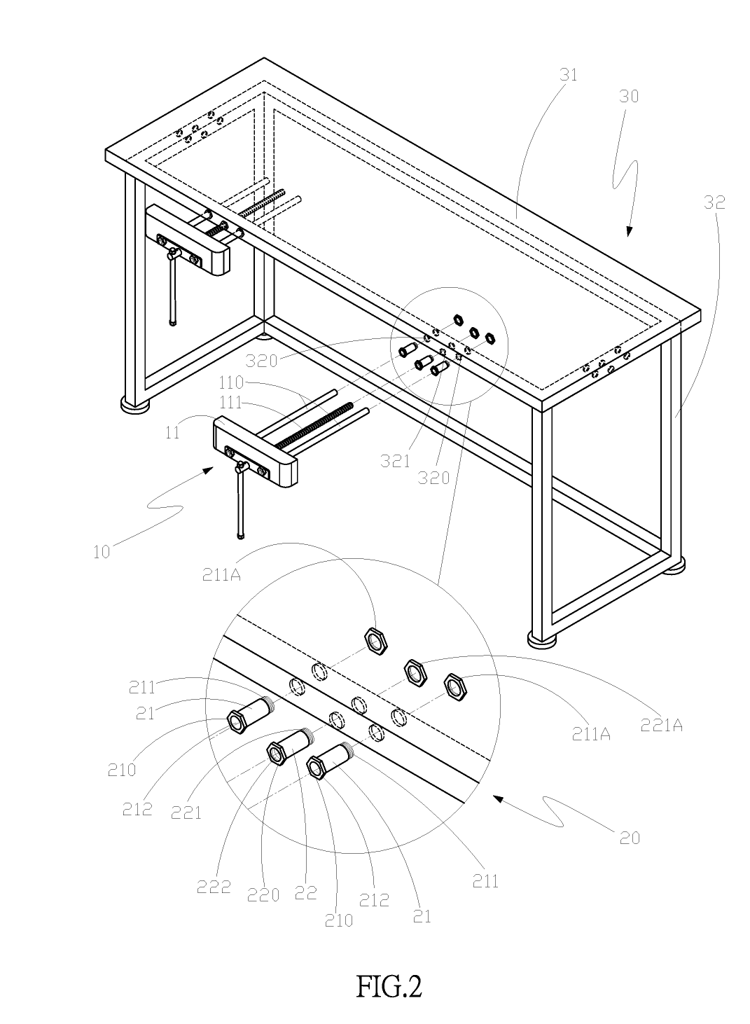

FIG. 1 is a perspective view of a worktable clamp structure according to an embodiment the present invention. FIG. 2 is a partial exploded view of the worktable clamp structure according to the embodiment the present invention. The worktable clamp structure comprises a clamp unit 10, a bushing unit 20, and a worktable 30.

The clamp unit 10 includes a clamping seat 11. The clamping seat 11 is provided with two support rods 110 at two sides thereof and a rotatable screw rod 111 between the two support rods 110. The two support rods 110 and the screw rod 111 of the clamping seat 11 are arranged in a non-relativistic horizontal state.

The bushing unit 20 includes at least two insertion bushings 21 and at least one screw bushing 22. A front end of each insertion bushing 21 is provided with a first front stopper 210. A rear end of each insertion bushing 21 has a first rear screw portion 211. The first rear screw portion 211 is provided with a first fastening member 211A. Each insertion bushing 21 has a through hole 212 extending from front to back. A front end of the screw bushing 22 is provided with a second front stopper 220. A rear end of the screw bushing 22 has a second rear screw portion 221. The second rear screw portion 221 is provided with a second fastening member 221A. The screw bushing 22 has an inner screw hole 222 extending from front to back. The two support rods 110 of the clamp unit 10 are slidably inserted through the through holes 212 of the two insertion bushings 21. The screw rod 111 is movably threadedly connected to the inner screw hole 222 of the screw bushing 22.

The worktable 30 includes a tabletop 31 and a frame 32 fixedly connected to the tabletop 31. Each of side edges of the frame 32 is provided with a plurality of pairs of side perforations 320. A central perforation 321 is provided between each pair of the side perforations 320. Each pair of the side perforations 320 and the central perforation 321 are arranged in a non-relativistic horizontal state. The two insertion bushings 21 of the bushing unit 20 are inserted through a corresponding pair of the side perforations 320 of the frame 32, and the first screw portions 211 at the rear ends of the two insertion bushings 21 extend out of the pair of the side perforations 320 and are locked with the first fastening member 211A. The screw bushing 22 is inserted through the central perforation 321 of the frame 32, and the second rear screw portion 221 at the rear end of the screw bushing 22 extends out of the central perforation 321 and is locked with the second fastening member 221A.

With the above-described configuration, the worktable clamp structure of the present invention is completed.

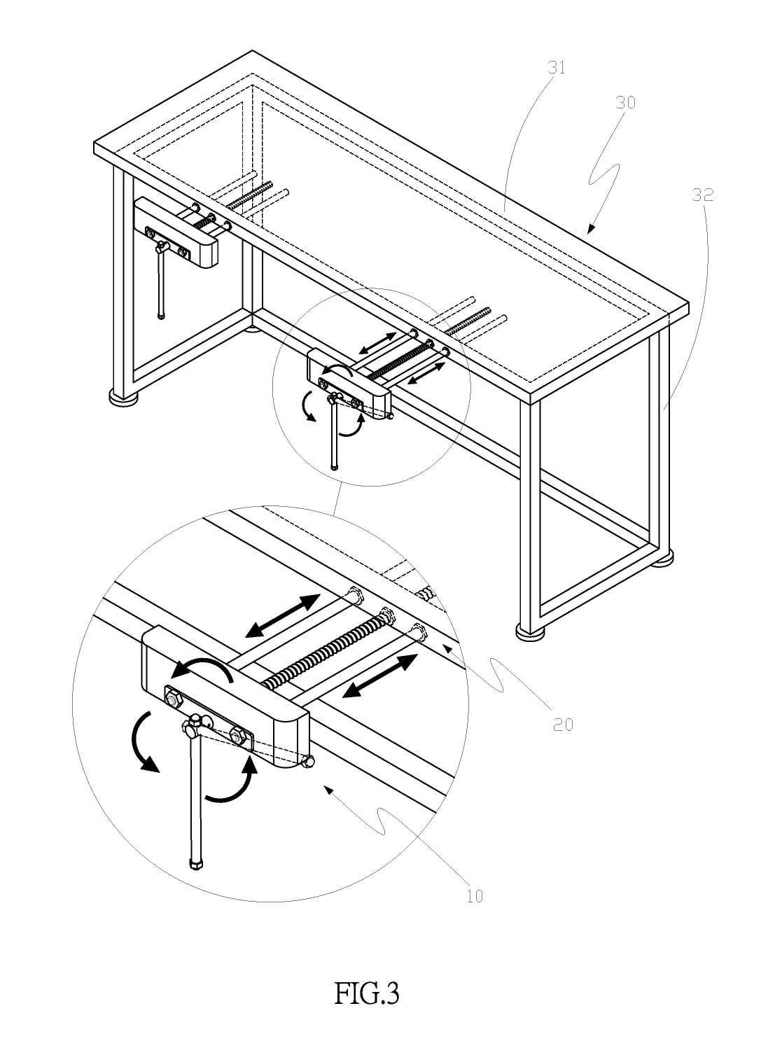

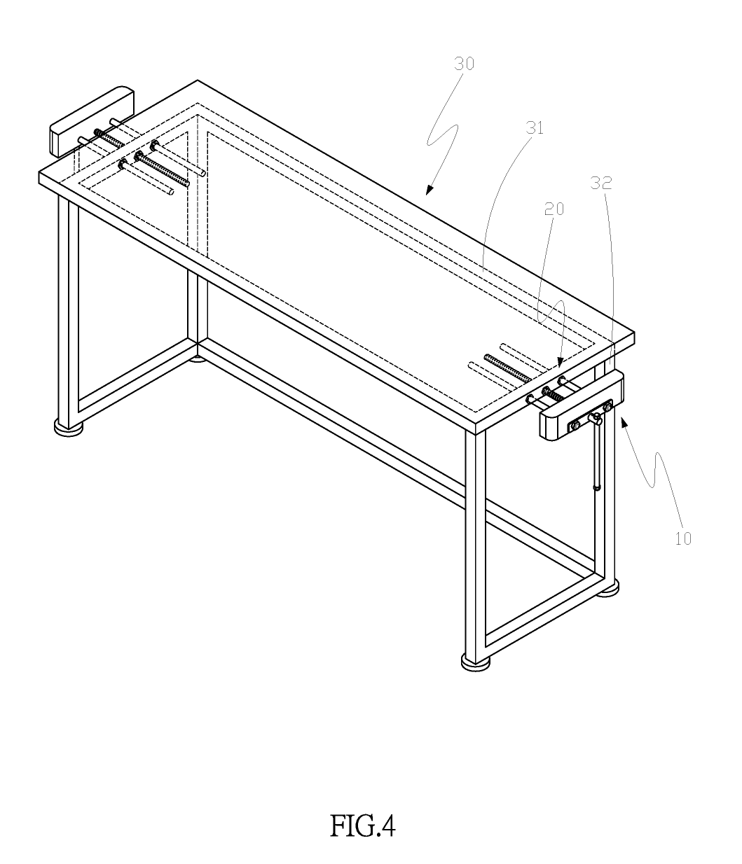

FIG. 1 is a perspective view of the worktable clamp structure. FIG. 2 is a partial exploded view of the worktable clamp structure. FIG. 3 is a schematic and partial enlarged view showing the operation of the worktable clamp structure. FIG. 4 is a schematic view showing the clamp unit and the bushing unit mounted the side edge of the worktable of the worktable clamp structure. The two insertion bushings 21 of the bushing unit 20 are inserted through a corresponding pair of the side perforations 320 of the frame 32, and the first screw portions 211 at the rear ends of the two insertion bushings 21 extend out of the pair of the side perforations 320 and are locked with the first fastening member 211A. The screw bushing 22 is inserted through the central perforation 321 of the frame 32, and the second rear screw portion 221 at the rear end of the screw bushing 22 extends out of the central perforation 321 and is locked with the second fastening member 221A. The support rods 110 of the clamp unit 10 are slidably inserted through the insertion bushings 21 of the bushing unit 20. The screw rod 111 of the clamp unit 10 is movably threadedly connected to the screw bushing 22 of the bushing unit 20. The clamp unit 10 and the bushing unit 20 can be mounted to the side perforations 320 and the central perforation 321 at either side edge of the frame 32 of the worktable 30 according to the demand, without the need to fix the clamp unit 10 to the tabletop 31 of the worktable 30 in a destructive manner. This can prevent deformation of the clamping seat 11 due to the force applied thereto to achieve structural stability and ease of use.

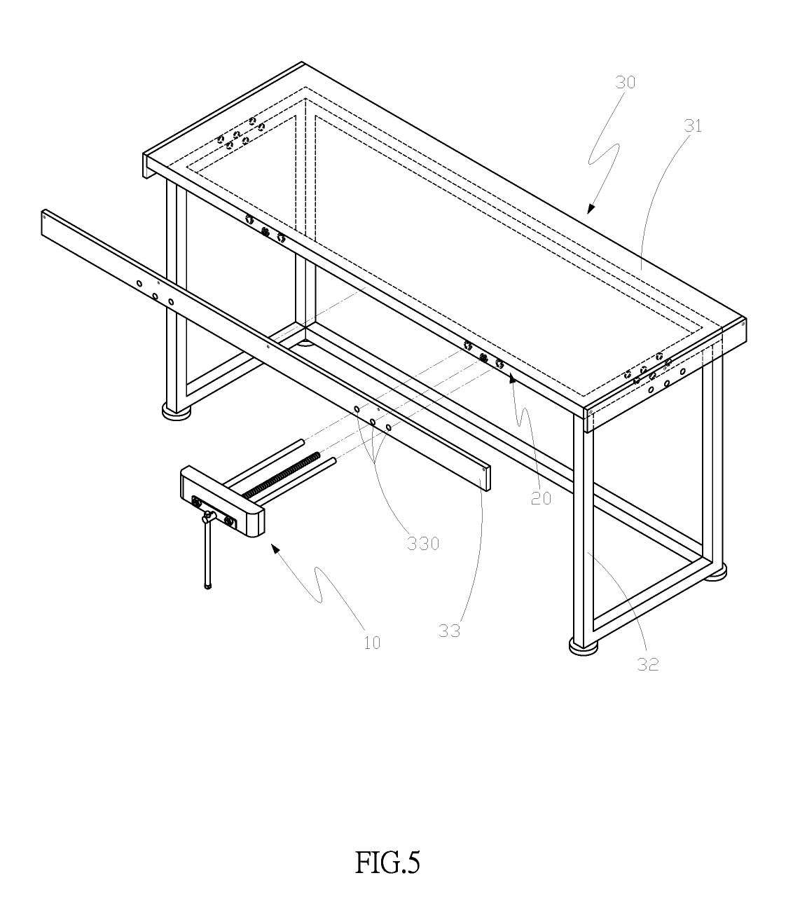

FIG. 5 is a schematic view showing the stop boards provided at the side edges of the workatable according to another embodiment of the present invention. This embodiment is substantially similar to that of FIGS. 1-4 with the exceptions described hereinafter. Each of the side edges of the tabletop 31 of the worktable 30 is provided with a stop board 33. The stop board 33 has a plurality of bores 330. The bores 330 at two sides of the stop board 33 and the bore 330 at a central portion of the stop board 33 are arranged in a non-relativistic horizontal state. The bushing unit 20 is inserted and fixed to the bores 330 of the stop board 33 and the side perforations 320 and the central perforation 321 of the frame 32, and then the clamp unit 10 is movably mounted to the bushing unit 20 in order to increase the versatility of the present invention.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A worktable clamp structure, comprising:
a clamp unit, the clamp unit including a clamping seat, the clamping seat being provided with two support rods at two sides thereof and a rotatable screw rod between the two support rods; and
a bushing unit, the bushing unit including at least two insertion bushings and at least one screw bushing, a front end of each insertion bushing being provided with a first front stopper, a rear end of each insertion bushing having a first rear screw portion, the first rear screw portion being provided with a first fastening member, each insertion bushing having a through hole extending from front to back, a front end of the screw bushing being provided with a second front stopper, a rear end of the screw bushing having a second rear screw portion, the second rear screw portion being provided with a second fastening member, the screw bushing having an inner screw hole extending from front to back, the two support rods of the clamp unit being slidably inserted through the two insertion bushings, the screw rod being movably threadedly connected to the screw bushing.

2. The worktable clamp structure as claimed in claim 1, wherein the two support rods and the screw rod of the clamping seat of the clamp unit are arranged in a non-relativistic horizontal state, the two support rods are inserted through the two insertion bushings of the bushing unit, and the screw rod is threadedly connected to the screw bushing of the bushing unit.

3. A worktable clamp structure, comprising:
a clamp unit, the clamp unit including a clamping seat, the clamping seat being provided with two support rods at two sides thereof and a rotatable screw rod between the two support rods;
a bushing unit, the bushing unit including at least two insertion bushings and at least one screw bushing, a front end of each insertion bushing being provided with a first front stopper, a rear end of each insertion bushing having a first rear screw portion, the first rear screw portion being provided with a first fastening member, each insertion bushing having a through hole extending from front to back, a front end of the screw bushing being provided with a second front stopper, a rear end of the screw bushing having a second rear screw portion, the second rear screw portion being provided with a second fastening member, the screw bushing having an inner screw hole extending from front to back, the two support rods of the clamp unit being slidably inserted through the two insertion bushings, the screw rod being movably threadedly connected to the screw bushing; and
a worktable, the worktable including a tabletop and a frame fixedly connected to the tabletop, each of side edges of the frame being provided with a plurality of pairs of side perforations, a central perforation being provided between each pair of the side perforations, the two insertion bushings of the bushing unit being inserted through a corresponding pair of the side perforations of the frame, the first screw portions at the rear ends of the two insertion bushings extending out of the pair of the side perforation and being locked with the first fastening member, the screw bushing being inserted through the central perforation of the frame, the second rear screw portion at the rear end of the screw bushing extending out of the central perforation and being locked with the second fastening member.

4. The worktable clamp structure as claimed in claim 3, wherein the two support rods and the screw rod of the clamping seat of the clamp unit are arranged in a non-relativistic horizontal state, each pair of the side perforations and the central perforation of the frame of the worktable are arranged in a non-relativistic horizontal state, the two insertion bushings of the bushing unit are inserted through a corresponding pair of the side perforations of the frame, the first screw portions at the rear ends of the two insertion bushings extend out of the pair of the side perforations and are locked with the first fastening member, the screw bushing is inserted through the central perforation of the frame, and the second rear screw portion at the rear end of the screw bushing extends out of the central perforation and is locked with the second fastening member.

5. The worktable clamp structure as claimed in claim 3, wherein each of side edges of the tabletop of the worktable is provided with a stop board, the stop board has a plurality of bores, the bores at two sides of the stop board and the bore at a central portion of the stop board are arranged in a non-relativistic horizontal state, the bushing unit is inserted and fixed to the bores of the stop board and the side perforations and the central perforation of the frame, and the clamp unit is movably mounted to the bushing unit.
